(19) United States
(12) Patent Application Publication
(10) Pub. No.: US 2005/0047773 A1
(43) Pub. Date: Mar. 3, 2005

(54) Portable device

(75) Inventors: Kanji Satake, Yokohama-shi (JP); Eiji Kataoka, Yokohama-shi (JP); Ken Tomatsu, Yokohama-shi (JP); Hiroyuki Mizuno, Yokohama-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/898,696

(22) Filed: Jul. 23, 2004

(30) Foreign Application Priority Data
Jul. 24, 2003 (JP) 2003-201099
Jul. 24, 2003 (JP) 2003-201100

(51) Int. Cl. G03B 7/26

(52) U.S. Cl. 396/301

(57) ABSTRACT

A portable device includes a camera unit having an imaging device, a housing for supporting the camera unit so as to be rotatable and stoppable at a photographing in the photographing position, and a control device for activating the imaging device when the detection device detects that the camera unit is rotated to the photographing position.

### BACKGROUND OF THE INVENTION

1. Field of the Invention

The present invention relates to a portable device such as a portable telephone, a PDA (Personal Digital Assistant), a digital camera, a notebook personal computer or the like, which is fitted with a rotatable camera unit.

Priority is claimed on Japanese Patent Application Nos. 2003-201099, filed Jul. 24, 2003, and 2003-201100, filed Jul. 24, 2003, the contents of which are incorporated herein by reference.

2. Description of Related Art

In recent years, the demand for portable telephones, PDAs, digital cameras, notebook personal computers and the like equipped with camera units has progressively increased. An example of such a portable terminal which is equipped with a camera unit is shown in FIGS. 10 and 11. With this portable terminal 35, a camera unit is covered with a lens cover when the camera is not in use. When a slide lever 37 is slid, the lens cover 36 opens as in FIG. 11, and the camera 38 and a mirror 39 are exposed. With this portable terminal, it is arranged for an electrical switch to be assembled to the mechanism of the slide lever 37, so that the portable terminal 35 automatically starts a predetermined camera application upon detection of the fact that the lens cover 36 has opened.

If the lens cover 36 is opened and closed manually in this manner, then it is possible to be sure that the user has the intention of starting the camera function of the portable terminal. Accordingly, it is possible to start the camera application automatically.

On the other hand, a portable terminal of a type in which a camera unit rotates is disclosed in, for example, Japanese Unexamined Patent Application, First Publication No. H11-164273. With this portable device, it is possible, while viewing all LCD, not only to photograph an object to be photographed on the side opposite to the LCD by operating the camera unit, but also to photograph an object to be photographed on the same side as the LCD (i.e. the user himself). In addition, a portable device is also proposed in which openings are provided both upon the surface side and upon the rear surface side of the housing, and which is equipped with a camera which is arranged so that it can be exposed at either of these openings.

However, with this portable terminal, since no cover is provided for the camera unit, it is not possible to be sure that the user intends to perform photography, as in the case of the portable terminal 35 of FIG. 10. Accordingly, it has not been possible to start a camera application automatically.

In addition, when attempting to perform photography using a camera which is fitted to a portable terminal, if the camera can be seen upon the side of the user, then the user is able to point the camera in any desired direction. However, if the camera is hidden, it is troublesome to get an idea of the direction in which the camera is pointing without shifting the camera to a position in which it can be viewed. In particular, it may also happen that an instantaneous shutter chance is missed, if it is not possible to specify the position of the camera at some instant.

The present invention has been conceived and created in the light of the above described situation, and its first object is, in the case of a portable terminal which has a rotating type camera, to provide a portable terminal which can start a camera application automatically; while, in addition, its second object is to provide a portable device, in which the position of a camera can be easily specified.

### SUMMARY OF THE INVENTION

The first aspect of the present invention is a portable device having a camera unit having an imaging device, a housing for supporting the camera unit so as to be rotatable and stoppable at a photographing position and at a storage position, a detection device for detecting that the camera unit is in the photographing position, and a control device for activating the imaging device when the detection device detects that the camera unit is rotated to the photographing position.

In addition, it is desirable that there be at least two photographing position, a position at which the camera unit is rotated from the storage position in one direction, and a position at which it is rotated in another direction.

In addition, it is desirable for the control device to detect which among the plurality of photographing positions the camera unit is in, based upon the result of the detection device, and to control so as to change the orientation in which the image is outputted from the imaging device corresponding to the photographing position which is detected.

In addition, it is desirable for the portable device to have a camera operating part for operating the control device so as to activate the imaging device, wherein the control device activates the imaging device only when it is detected that the camera unit is in the photographing position, when the camera operating part is operated.

In addition, it is desirable for the detection device to be a switch which is depressed by the rotation of the camera unit, and for the switch to be depressed only when the camera unit is in the photographing position.

In addition, it is desirable for the housing to comprise an opening which exposes a portion of the camera unit, and for an indicator member to be provided on an outer surface of the camera unit exposed in the opening, when the camera unit is in the storage position.

In addition, it is desirable that there be at least two photographing positions, a position at which the camera unit is rotated from the storage position in one direction, and a position at which it is rotated in another direction, and the opening is provided at each of the photographing position.

In addition, it is desirable for the camera unit to comprise two casings which are separable in a shaft direction, and for the indicator member to be affixed so as to stride a seam between the two casings.

In addition, it is desirable for a flat surface to be provided which strides the seam between the two casings, and for the indicator member to be a label which is adhered upon the flat surface.

In addition, it is desirable for the indicator member to be made from a transparent material, and for printing to be performed upon the surface of the indicator member which comes to be on the inside when it is fitted to the camera unit, or upon its surface which comes to be on the outside, in a position which overlaps the seam.

The second aspect of the present invention is a portable device having a camera unit having an imaging device, a housing which supports the camera unit so as to be rotatable, and so that it can be stopped at a photographing position and at a storage position, an opening which is provided to the housing, and which exposes the image which detects, at least, that the camera unit is in the photographing position; and an indicator member which is exposed in the opening at an outer surface of the camera unit, when the detection device does not detect that it is in the photographing position.

The third aspect of the present invention is a method of controlling a portable device, the portable device having a camera unit having an imaging device, and a housing which supports the camera unit so as to be rotatable, and so that it can be stopped at a photographing position and at a storage position, and the method having a detection step of detecting, at least, that the camera unit is in the photographing position, and a starting step of starting the imaging device, when it is detected in the detection step that the camera unit is in the photographing position.

Here, it is desirable for the photographing position to be at least two locations: a position in which the camera unit is rotated from the storage position in one direction, and a position in which it is rotated in another direction.

In addition, it is desirable for the starting step to detect which among the plurality of photographing positions the camera unit is in, based upon the result of the detection device, and to control so as to change the orientation in which the image is outputted from the imaging device corresponding to the photographing position which is detected.

In addition, it is desirable for there to be further included a camera operation step which can command the starting step to put the imaging device into its starting state, and for the starting step, when the camera operation step is operated, to control the imaging device so as not to start the imaging device, if it is not detected that the camera unit is in the photographing position.

### BRIEF DESCRIPTION OF THE DRAWINGS

FIG. 1 is a perspective view showing an opened state of a portable device according to a first aspect of the present invention, as seen from the side of its front surface.

FIG. 2 is a perspective view showing the opened state of this portable device according to the first aspect of the present invention, as seen from the side of its rear surface.

FIG. 3 is a perspective view showing a fitted state of a camera unit which is provided to this portable device according to the first aspect of the present invention.

FIG. 4 is a sectional view of FIG. 1 along the line A-A.

FIG. 5 is a sectional view of a click mechanism which is provided to this portable device according to the first aspect of the present invention.

FIG. 6 is a perspective view showing the camera unit which is provided to this portable device according to the first aspect of the present invention.

FIG. 7 is a perspective view showing the camera unit which is provided to this portable device according to the first aspect of the present invention, and is a view showing the vicinity of a detection mechanism.

FIG. 8 is a figure for explanation of the operating theory of the detection mechanism.

FIG. 9 is a flow chart related to starting a camera application of this portable device according to the first aspect of the present invention.

FIG. 10 is a perspective view of a prior art portable device, and is a figure showing a state in which a camera unit is covered by a lens cover.

FIG. 11 is a perspective view of the same portable device, and is a figure showing a state in which the camera unit is exposed.

FIG. 12 is a perspective view showing an opened state of a portable device according to a second aspect of the present invention, as seen from the side of its surface.

FIG. 13 is a perspective view showing the opened state of this portable device according to the second aspect of the present invention, as seen from the side of its rear surface.

FIG. 14 is a schematic enlarged sectional view of a display side housing of this portable device according to the second aspect of the present invention.

FIG. 15 is a exploded view of a camera unit which is provided to this portable device according to the second aspect of the present invention.

### DETAILED DESCRIPTION OF THE INVENTION

In the following, embodiments according to the present invention will be explained with reference to the drawings.

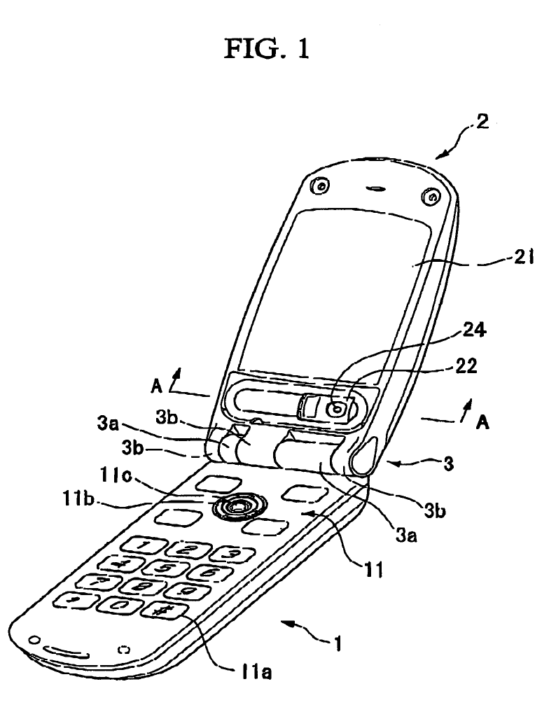

FIG. 1 is a figure showing a first aspect of the present invention, and is a perspective view showing the opened state of a portable device which employs the present invention from the side of its front surface.

The portable device includes, as the main body of the portable device, a lower housing section 1, an upper housing section 2 which has openings, and a hinge portion 3.

The lower housing section 1 is provided with an operation section 11 which includes tenkey pad buttons 11a, cursor buttons 11b, and a confirm button 11c. In addition, it includes a control device such as a CPU or the like (not shown in the figures) which controls the entire portable device. Various programs are stored in the control device, and it is endowed with various functions, such as a function which will be described hereinafter of putting the camera module 24 into a starting state if it is detected that the camera unit 22 has been rotated from a storage position in which a user cannot see the camera module 24 in the opening to a photographing position in which the user can see the camera module 24 in the opening as will be described hereinafter, a function which will be described hereinafter of converting the orientation in the vertical direction of images which are outputted to a display section 21 according to a plurality of photographing positions of the camera unit 22 which are provided, a function which will be described hereinafter of ensuring that the operation of the camera module 21 is not started if it is not detected that the camera unit 22 is in the photographing position, and the like. In addition, a camera application to be described hereinafter is stored, and, according to requirements, it is arranged for it to be called out and executed.

The upper housing section 2 includes the display section 21 and the camera unit 22.

The hinge portion 3 includes a lower hinge portion 3a which is made as a unit with the edge portion of the lower housing section 1 and an upper hinge portion 3b which is made as a unit with the edge portion of the upper housing section 2, and it connects together the lower housing section 1 and the upper housing section 2, and supports the upper housing section 2 with respect to the lower housing section 1 so that it remains free to rotate.

When the portable device is not in use it can be folded up around the hinge portion 3 as a fulcrum, so that the surface which includes the operation section 11 of the lower housing section 1 and its surface which includes the display section 21 of the upper housing section 2 are mutually brought against one another.

The display section 21 is made from, for example, a liquid crystal display device, and it is arranged for it to display character information and the like which has been inputted via the operation section 11, information of characters or images or the like which is stored in a memory not shown in the figures which is housed within the portable device, and, if photography is being performed by using the camera unit 22, information such as display of images which have been photographed, or real time display of moving images which have been taken by the camera unit 22, and information such as images or the like which have been transmitted or received by a signal transmission and reception device not shown in the figures which is housed within the portable device.

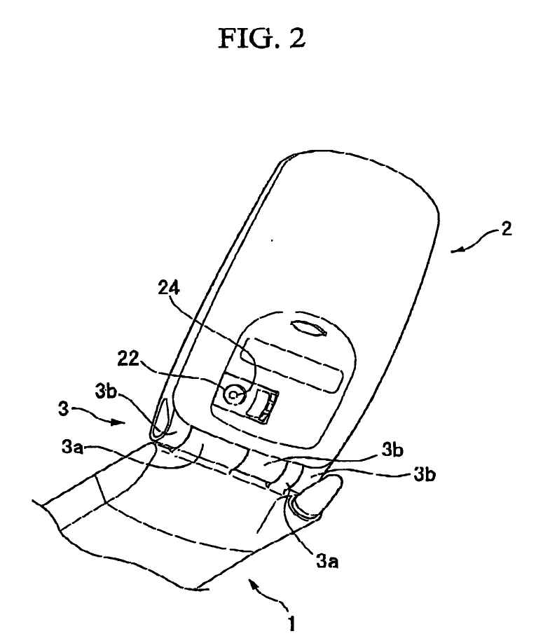

When the camera unit 22 is performing photography in a state in which, as shown in FIG. 1, the camera module 74 is oriented towards the side of the display section 21 as will be described hereinafter, it becomes possible for it to photograph an object to be photographed upon the side of the display section 21 while the display section 21 is being viewed. On the other hand, when the camera unit 22 is rotated from this state within the upper housing section 2 while rotating its edge portion with a finger or the like, it is then put into a state in which the camera module 24 faces the side opposite from the display section 24; that is, the camera module 24 is exposed in a opening which opens on the opposite side, as shown in FIG. 2. When photography is performed in this state, it becomes possible to photograph an object to be photographed which is on the opposite side from the display section 21 while viewing the display section 21.

The structure of the camera unit 22 will now be described in concrete terms.

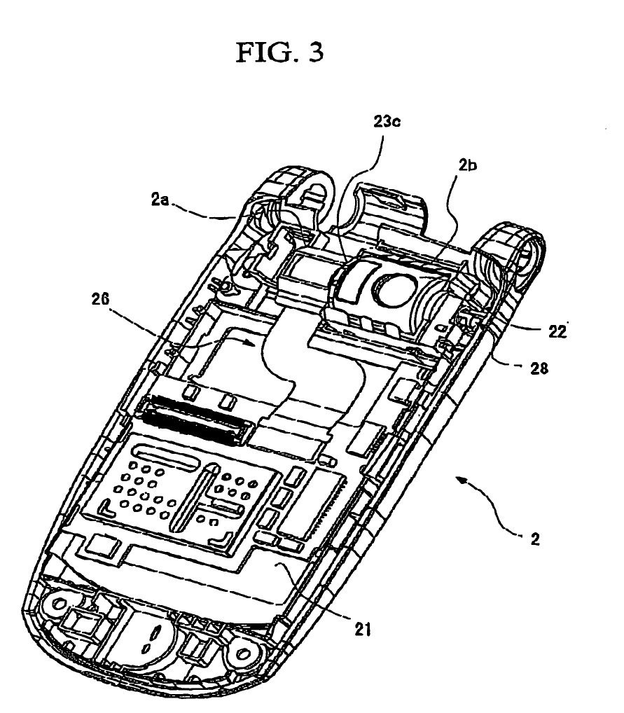

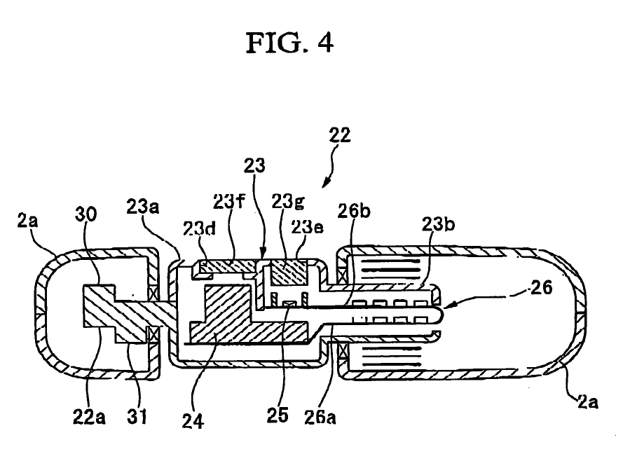

As shown in FIGS. 3 to 6, the camera unit 22 is housed in the upper housing section 2, and it is formed in a roughly circular tubular shape so as to extend in the widthwise direction of the upper housing section 2. This camera unit 22 includes a rotating body 23 which includes a shaft 22a with both ends of the shaft 22a being supported in a rotatable manner within the upper housing section 2, a camera module 24 and a light emission section 25 which are disposed within the rotating body 23 and which serve as an imaging device, and a flexible printed-circuit board 26 which is provided at an end portion of the rotating body 23 and which is connected to the camera module 24 and the light emission section 25.

In addition, the camera unit 22 is housed within a casing 22 in the upper housing section 2. A metal plate 2b is adhered upon the outside of this casing 2a as a static electricity countermeasure.

The rotating body 23 is made so as to include a large diameter portion 23a and a small diameter portion 23b which are upon the same axis and are of different diameters, and these large diameter portion 23a and small diameter portion 23b are connected together. In addition, there are provided a plurality of concave portions 23c on the outer circumference at the end portion of the large diameter portion 23a towards the side of the small diameter portion 23b, so that as to be easily rotatable when the rotating body 23 is rotated with the tip of a finger.

In addition, the rotating body 23 is made so as to be separable in the vertical direction, so that it is possible to fit the camera module 24, the light emission section 25, and the flexible printed circuit board 26 within its interior. In addition, upon the side surface of the rotating body 23, there are provided respective aperture portions 23d and 23e which allow the camera module 24 and the light emission section 25 to be visible from the outside; and, in these aperture portions 23d and 23e, there are provided respective transparent plates 23f and 23g, so as to protect the photographic window of the camera module 24 and the light emission surface of the light emission section 25.

Furthermore, in the following, the direction in which the transparent plate 23f is facing, in other words the photographic direction, will simply be termed “the direction of the camera unit 22”.

The camera module 24 is arranged upon one extended portion 26a of the flexible printed-circuit board 26, and is electrically connected to this extended portion 26a. This camera module 24 is one which photographs an object to be photographed with a drive section not shown in the drawings, and utilizes, for example, a CCD or a CMOS or the like.

The light emission section 25 is arranged upon another extended portion 26b of the flexible printed-circuit board 26, and is electrically connected to this extended portion 26b. This light emission section 25 is endowed with a function of, when an object to be photographed is photographed by the camera module 24, acting as a flash which emits light directly forward to photograph the object to be photographed due to the action of a drive section not shown in the figures, and utilizes, for example, white colored LEDs or the like.

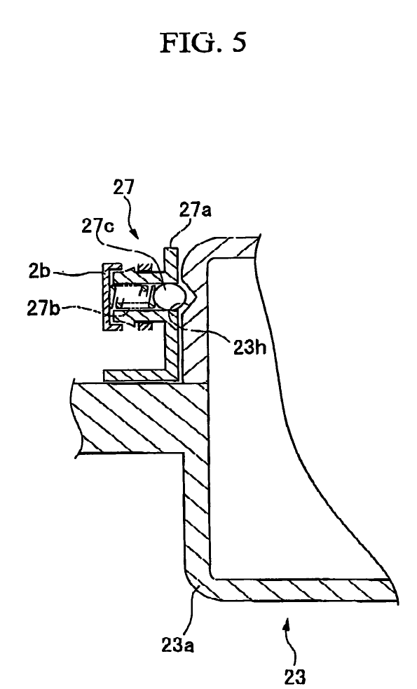

In addition, as shown in FIG. 5, at the end portion of the large diameter portion 23a which is included in the rotating body 23, there is provided a click mechanism 27 for fixing the camera unit 22 in a predetermined position when it has been rotated. This click mechanism 27 includes a casing 27a, a screw 27b which is provided within the casing 27a, and a metallic ball 27c which is pressed by the spring 27b against the rotating body 23.

The spring 27b is pressed from the outside of the casing 27a by the metallic plate 2b which is provided on the exterior of the casing 2a. In addition, a dent portion 23h is provided at the end portion of the large diameter portion 23a which is in contact with the metallic ball 27c, and, when the camera unit which has been turned by a finger is stopped, the metallic ball 27c is pressed against the large diameter portion 23a by the elastic force of the ring 27b and is engaged into the dent portion 23h, so that the camera unit 22 is fixed into a predetermined position.

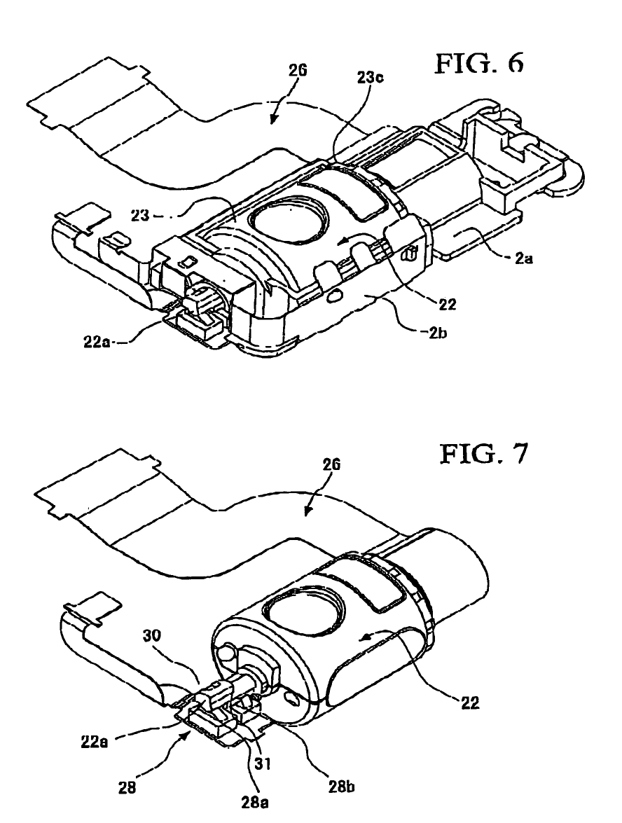

In addition, as shown in FIG. 7, a detection mechanism (detection device) 28 is provided at the end portion of the camera unit 22, and, when the camera unit 22 is rotated, it detects the position thereof. This detection mechanism 28 includes two switches as shown in the figure, a first detection switch 28a and a second detection switch 28b, and is arranged to detect which of the following positions the camera unit 22 is in: a position (a first photographing position) in which the camera unit 22 is pointed towards one of the surfaces of the portable terminal; a position (a second photographing position) in which the camera unit 22 is pointed towards the other one of the surfaces of the portable terminal; ad a position (a storage position) in which the transparent plate 23f of the camera module 24 is hidden in the housing 2.

In concrete terms, two projecting portions 30 and 31 are provided upon the shaft 22a, and one of these projecting portions 30 opens and closes the first detection switch 28a, while the other projecting portion 31 opens and closes the second detection switch 28b. The two detection switches 28a and 28b are both provided at the same angular position with respect to the circumferential direction of the shaft 22a, but the two projecting portions 30 and 31 are provided at angular positions with respect to the circumferential direction of the shaft 22a which differ by 180°. Accordingly, the timing of the ON and OFF of the two detection switches 28a and 28b differs by a phase of 180° with respect to the rotational angle of the camera unit 22.

When the camera unit 22 is positioned to face the side of the user himself (the side of the display section 21), then the fist detection switch 28a is ON, while the second detection switch 28b is OFF. When the camera unit 22 is positioned to face the side of another person with respect to the user, then the first detection switch 28a is OFF, while the second detection switch 28b is ON. In addition, when the transparent plate 23f of the camera module 24 is in the hidden position, the detection switches 28a and 28b are both OFF.

In addition, along with the projecting portions 30 and 31 respectively opening and closing the detection switches 28a and 28b, it is arranged for them to be stopped by these switches 28a and 28b. In other words, when the user rotates the camera unit22 towards himself, along with the projecting portion 30 turning the first detection switch 28a ON, also the detection switch 28a itself acts as a stopper and stops the projecting portion 30, and accordingly limits suppresses excessive rotation of the camera unit 22. The same holds true for the projecting portion 31 and the detection switch 28b. Due to this, the camera unit comes to be rotatable only through a range of 180°.

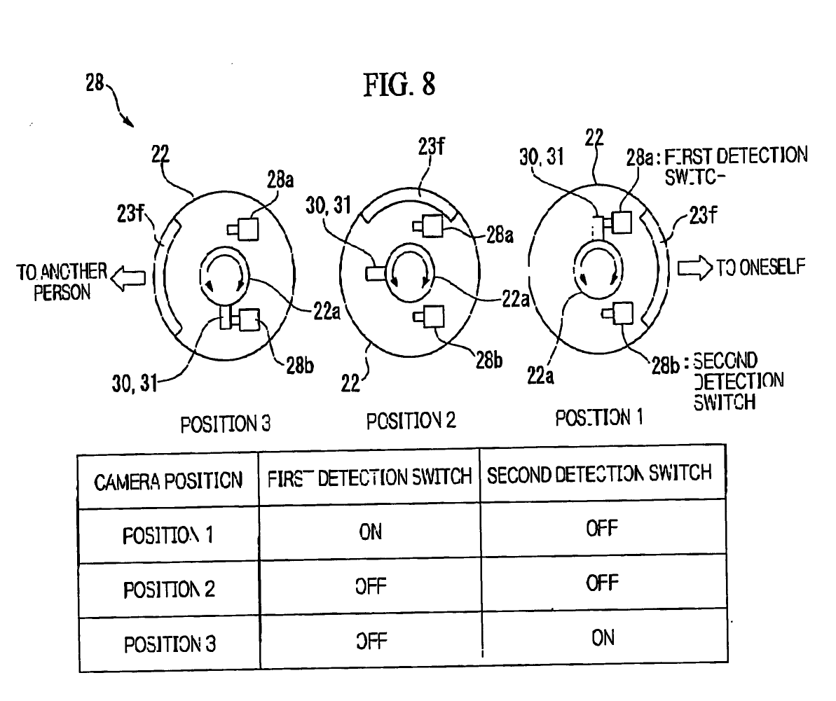

The theory of this detection mechanism 28 is shown in FIG. 8. FIG. 8 differs from FIG. 7 in that the two projecting portions 30 and 31 are provided in the same angular position with respect to the circumferential direction of the shaft 22a, while the two detection switches 28a and 28b are provided in different angular positions with respect to the circumferential direction of the shaft 22a.

The detection switches 28a and 28b are turned ON and OFF by the projecting portions 30 and 31 pressing the detection switches 28a and 28b according to the rotational angle of the camera unit 22.

When the camera unit 22 is facing the side of the user, the first detection switch 28a is ON and the second detection switch 28b is OFF (position 1). When the user rotates the camera unit 22, the projecting portion 30 is removed from the first detection switch 28a, and both of the detection switches go to OFF (position 2). When the camera unit 22 is further rotated, the camera unit 22 faces the outside of the portable terminal, and the second detection switch 28b is pressed by the projecting portion 31, so that the first detection switch 28a comes to be OFF while the second detection switch 28b comes to be ON (position 3). When again the camera unit 22 is rotated in the direction to return it to its original position, the projecting portion 31 is removed from the second detection switch 28b, and both of the detection switches go to OFF (position 2).

Next, the function and the operation of the portable device which has the above described structure will be explained.

When performing photography of an object to be photographed using this portable device, from the state in which the portable device is folded up when not in use, the upper housing section 2 which is folded against the lower housing section 1 is opened up by hand. Then, the user rotates the camera unit 22, so that the camera unit 22 is brought to face towards the object to be photographed (the user himself, or another person). Then, photography is performed by pressing the confirm button 11c of the operation section 11 which is provided on the lower housing section 1.

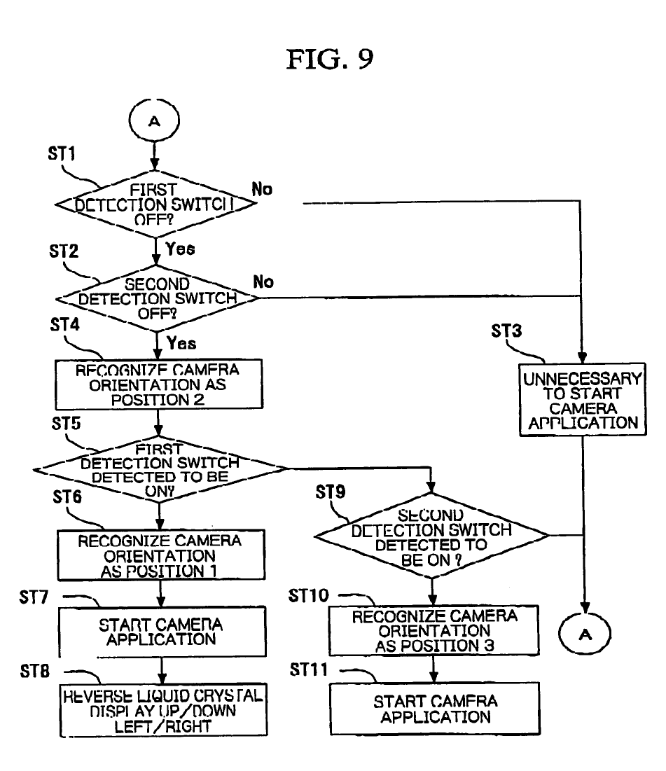

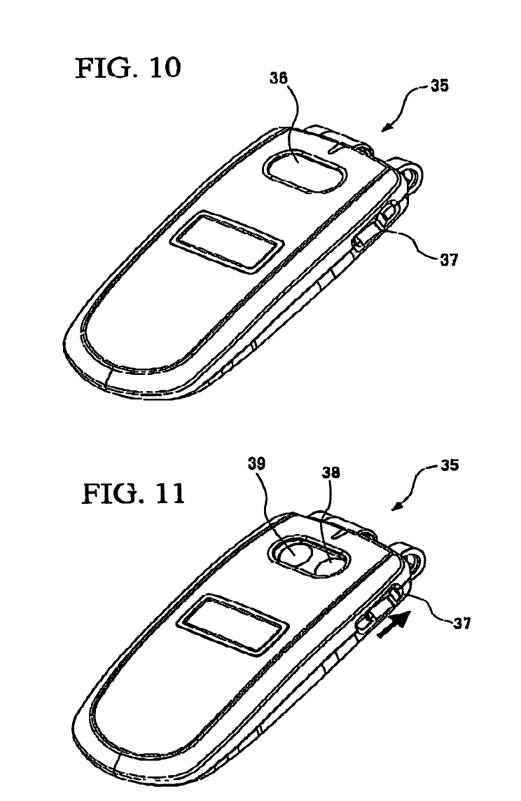

The operation on the side of the portable terminal at this time will now be explained using FIG. 9.

In this example, if the transparent plate 23f of the camera module 24 has been rotated towards an object to be photographed from its position in which it is hidden in the housing 2, then a camera application is automatically started.

In steps ST1 and ST2 of FIG. 9, the state of the detection switches 28a and 28b is detected. If either of them is ON, then it is not necessary to perform automatic starting of the camera application, since this is a state after the camera module 24 has already been rotated to face towards the side of an object to be photographed, and the flow of control returns to the beginning. If both of the detection switches 28a and 28b are OFF, then, in a step ST4, it is recognized that the present state is position 2 (the intermediate position). Next when, in a step ST5, it is detected that the first detection switch 28a has gone to ON, then, in a step ST6, it is recognized that the camera direction is position 1, and, in a step ST7, the camera application is started. Since, in the case of this position 1, the object to be photographed is the user himself, accordingly the display upon the liquid crystal is flipped up/down and left/right. By doing this, the up/down reversal caused by the rotation of the camera is controlled, and moreover, since it is possible to reflect the image of the camera in the liquid crystal screen while reversing it left/right, the user can easily check his own posture by using the liquid crystal screen like a mirror.

When it has not been possible to detect that the first detection switch 28a is ON, the flow shifts to a step ST9.

If, in this step ST9, it is detected that the second detection switch 28b is ON, then, in a step ST10, it is recognized that the direction of the camera is position 3, and in a step ST11, the camera application is started.

If it has not been possible to detect in the step ST9 that the second detection switch 28b is ON, then the flow returns to the start. Furthermore, here, by camera application, there is meant processing which performs supply of electrical power to the camera module 24, which accumulates an image in a backup memory which is not particularly shown in the figures, and the like.

As described above, in this embodiment, if the position of the camera is changed from the intermediate position to one's own side (or to the side of another person), then it is possible to determine that the user is using the camera, and to start a camera application automatically.

In addition, the first detection switch 28a and the second detection switch 28b also act as stoppers for limiting the rotation of the camera unit 22. Accordingly, it is not necessary to provide any other construction for limiting the rotational movement of the camera unit 22, and thus it is possible to realize simplification of the structure and increased compactness.

In addition, if the camera unit is pointed towards oneself, then it is possible to prevent up/down reversal in the display section 21 caused by the rotation of the camera by changing the direction of output of the image of said camera unit, as compared to the case in which it is pointed towards another person.

In addition, since, in this embodiment, it is possible to detect the position in which the transparent plate 23f of the camera module 24 is hidden in the housing 2, accordingly it is possible to operate the portable terminal in the following manner.

Since, in the case of position 2, the housing of the portable telephone itself interferes with the angle of view over which it is possible to perform photography with the camera, accordingly it would also be acceptable to stop the camera function, or, during it, to display a different image upon the display section 21, instead of the image which is being photographed by the camera.

In addition, if during photography of a moving image rotational operation of the camera unit 22 is performed, so that photography of the other side is performed, then, while both of the detection switches 28a and 28b are OFF, photography is temporarily stopped, and the system waits in a pause state until next the detection switch 28a or the detection switch 28b turns to ON. By doing this, it becomes possible to ensure that unnecessary images are not recorded during the limited image recording time.

In addition, it is possible to display an error message upon the display section 21 if the user attempts to start the camera application by key actuation when both of the detection switches 28a and 28b are OFF.

In addition, usually, the camera unit 22 is very often in the state of not being used, and many users normally leave it in the camera stored state of position 2, and only select the state of position 1 or position 3 when it becomes necessary to do so. Thus, as described above, this construction arranges for the detection switches to be in the state in which there is no load imposed upon either of them when the system is in position 2. Accordingly, it is possible to ensure that the detection switches 28a and 28b are kept in a state in which they are durable.

A detailed description of how an indicator member is set on a casing follows.

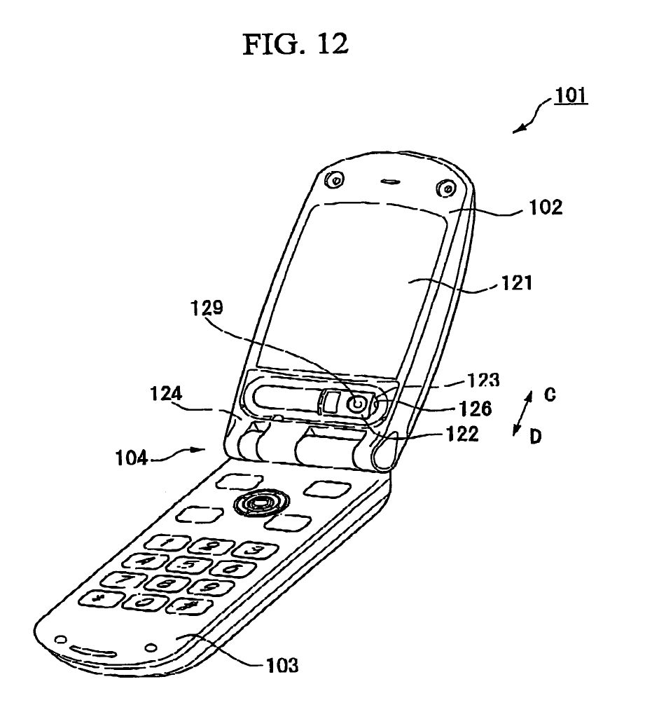

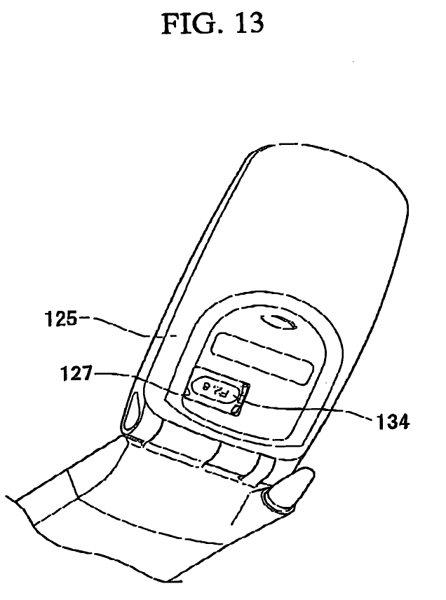

The portable device 101 according to the second aspect, as shown in FIGS. 12 and 13, includes a display side housing (housing) 102, an actuation side housing 103, and a hinge portion 104. When this portable device 101 is not in use, it can be folded up by the display side housing 102 and the actuation side housing 103 being folded together using the hinge portion 104 as a fulcrum.

The display side housing 102 includes a display section 121 and a camera unit 122. In addition a storage section 123 is provided to the display side housing 102, and this storage section 123 is formed to be pierced from the surface 124 of the display side housing 102 right through to its rear surface (the other surface) 125, so that it includes a first opening 126 and a second opening 127 which open in corresponding positions upon the surface 124 and the rear surface 125.

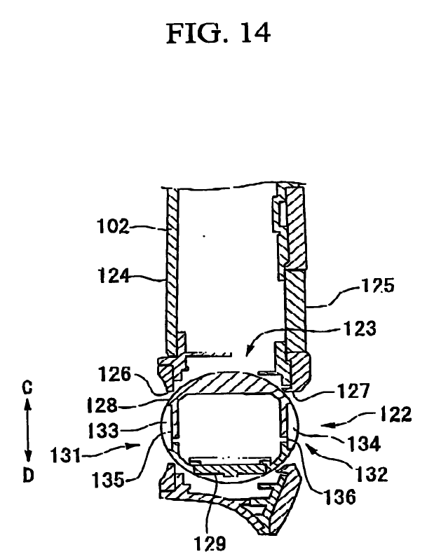

The camera unit 122, as shown in FIG. 14, includes a rotatable casing 128 of a roughly circular tubular shape which is housed within the display side housing 102, a camera 129 which is provided within this casing 128, a first indicator member 131 and a second indicator member 132 which are disposed in two locations upon the outer surface of the casing 128. Furthermore, the camera unit 122 is assembled into the display side housing 102 so that the orientation of the camera 129 can stop, with a click feeling, in three positions in FIG. 14, a rightward facing position, a downward facing position, and a leftward facing position; and the camera 129 is limited so that it cannot face upwards in FIG. 14. In other words, the camera 129 can only be oriented in three positions in FIG. 14: the rightward facing position, the downward facing position, and the leftward facing position.

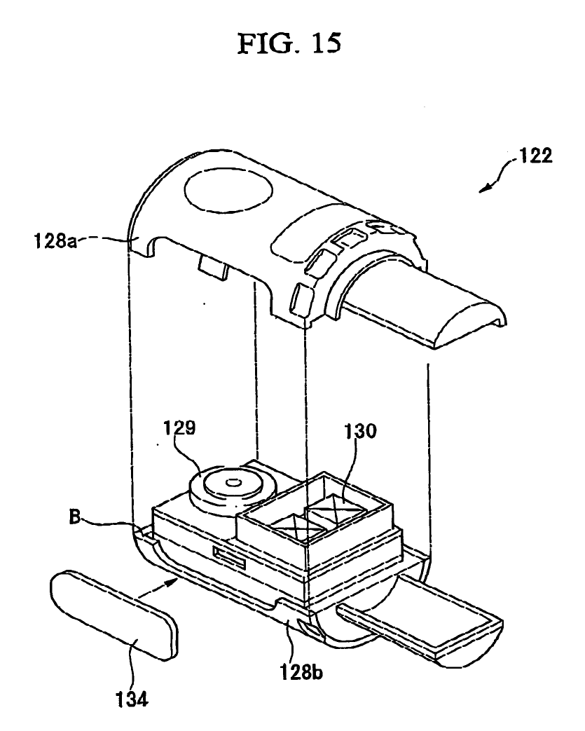

The casing 128, as shown in FIG. 15, is made up from a first casing 128a and a second casing 128b. Then, in the second casing 128b, there are disposed the camera 129 as an imaging section, and a light emission section 130, and the first casing 128a constitutes a construction which covers over these. Due to this, the division line B between the first casing 128a and the second casing 128b comes to be exist in a position which is different from the direction in which the camera 129 faces.

The first indicator member 131 and the second indicator member 132 are provided as straddling the division line B on both sides of the rotational axial line of the casing 128. In addition, these two indicator members 131 and 132 include a first label member 133 and a second label member 134 which are made from a transparent silicon resin, so that they are sandwiched between the casing 128a and the casing 128b. Then, characters which hide the division line B are printed upon the outer surfaces 135 and 136 of these two label members 133 and 134 on the casing 128 side. In these characters, for example, in this embodiment, the “F number” of the camera's ability may be written, but they are not ones which are limited to this; it would be acceptable for them to be arrow signs showing the direction of orientation of the camera 129, or the like. For example if, due to the orientation of the camera 129, its processing such as its zoom ratio or image reversal or picture quality adjustment or like changes, then it would also be acceptable to write a message to this effect, so that, from the point of view of the user, he may start the camera 129 in correspondence to the circumstances. It is very important for these characters or the like to be exposed from the openings 126 and 127, and, due to the characters or the like which are exposed, it is possible for the user to be aware of the rotational direction of the casing 29 during use.

In addition, with said camera unit 122, as shown in FIG. 12, if photography is being performed in the state in which the camera is facing towards the display side housing 102, then it becomes possible to photograph an object to be photographed upon the side of the display section 121 while viewing the display section 121. In addition, when the casing 128 is rotated by a finger or the like through a rotational angle of 90° from the state in which the camera 129 is facing to the side of the display section 121 in the direction from C to D as shown in FIG. 12, then, as shown in FIG. 14, the first indicator member 131 comes to appear from the first opening 126, while the second indicator member 132 comes to appear from the second opening 127. At this time, the camera 129 is faced towards the inside of the display side housing 102.

When, from the state shown in FIG. 14, the casing 128 is further rotated through an angle of 90° in the direction from C to D, then the camera 129 comes to be in the state in which it is facing towards the side of the rear surface 125, and, if photography is performed in this state, then it is possible to photograph an object to be photographed which is located at the side of the rear surface 125, while viewing the display section 121. In this state, neither the indicator member 131 nor the indicator member 132 comes to be exposed at the side of the opening 126. On the other hand, when from the state shown in FIG. 14 the casing 128 is rotated in the direction from D to C through an angle of 90°, then the camera 129 comes to be pointing towards the side of the surface 124. In this state, neither the indicator member 131 nor the indicator member 132 comes to be exposed at the side of the aperture portion 127.

The operation of the portable device according to this embodiment which has this structure will now be explained below.

When photographing an object to be photographed at the side of the rear surface 125 by using this portable device 101, then, as shown in FIG. 14, when the indicator member 131 is appearing from the first opening 126, the camera 129 is facing toward the interior of the display side housing 102. Due to this, by rotating the casing 128 through an angle of 90° in the direction from C to D, the camera comes to be facing towards the side of the rear surface 125. Then, after having pointed the camera 129 at the object to be photographed, photography is performed by pressing a predetermined shutter button.

In other words, by the first indicator member 131 and the second indicator member 132 being provided to the portable device 101 according to this embodiment, when the first indicator member 131 and the second indicator member 132 are exposed from the first opening 126 and the second opening 127, it becomes possible to be assured by ocular investigation that the camera 129 is not pointing either towards the side of the surface 124 or towards the side of the rear surface 125. Accordingly, it is possible to specify the position of the camera 129, and it becomes easy to check the rotational direction of the casing 128. In addition, it becomes possible to specify the position of the camera 129 by the presence or absence of the second indicator member 132, even in the state in which the portable device 101 is folded up. Yet further, when the user is looking at only one of the opening 126 and the opening 127, if either the indicator member 131 or the indicator member 132 is exposed, then he can understand that the camera 129 is pointing towards the interior of the display side housing 102, while, if neither of them is exposed, then the user can understand that the camera 129 is pointing at that opening 126 or opening 127 upon the side on which he is not looking.

In addition, it becomes possible to construct a camera unit 122 which loses nothing in attractiveness of appearance, since it is possible to cover the seam by providing the label member 133 and 134 which straddle over the division line B between the casing 128a and the casing 128b.

In addition, by covering characters which are printed upon the outer surfaces 135 and 136 of the casing 128 with the label members 135 and 136, it becomes possible to prevent deterioration of these characters in accompaniment with actuation of the casing 128 by rotation thereof by a finger or the like.

Furthermore although in particular, a transparent silicon resin is used with the portable device 101 according to this embodiment, thus making it difficult for a finger to slip from the label members which are used as the indicator members 131 and 132, alteratively, instead of this. it would also be acceptable to use a paper label, and in addition it would also be acceptable to use an alkyl resin or glass or the like.

In addition, although characters were printed on the surfaces of the casing 128 which contact the label members 133 and 134, instead of this, it would also be acceptable to print characters upon the surfaces of the label members 133 and 134 which confront the casing 128.

Furthermore, it would also be acceptable to apply the above described embodiment, not only to a portable telephone as a portable device, but also to a portable device incorporating a camera unit, such as, for example, a PDA, a digital camera, a notebook personal computer, or the like,

In addition, in the above described embodiment, it would also be acceptable for the devices which are included and which supplement additional new functions to the portable device to be, not only the light emission section, but also, for example, a microphone which inputs a voice, or a small-sized liquid crystal screen for the user to monitor the details of his actuation of the portable device, or the like.

While preferred embodiments of the invention have been described and illustrated above, furthermore these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A portable device comprising:
a camera unit having an imaging device;
a housing for supporting the camera unit so as to be rotatable and stoppable at a photographing position and at a storage position;
a detection device for detecting that the camera unit is in the photographing position; and
a control device for activating the imaging device when the detection device detects that the camera unit is rotated to the photographing position.

2. A portable device according to claim 1,
wherein there are at least two photographing positions,
a position at which the camera unit is rotated from the storage position in one direction; and
a position at which the camera unit is rotated in another direction.

3. A portable device according to claim 2, wherein the control device detects which among the plurality of photographing positions the camera unit is in, based upon the result of the detection device, and controls so as to change the orientation in which the image is outputted from the imaging device corresponding to the photographing position which is detected.

4. A portable device according to claim 1, further comprising a camera operating part for operating the control device so as to activate the imaging device,
wherein the control device activates the imaging device only when it is detected that the camera unit is in the photographing position, when the camera operating part is operated.

5. A portable device according to claim 1,
wherein the detection device is a switch which is depressed by the rotation of the camera unit, and
the switch is depressed only when the camera unit is in the photographing position.

6. A portable device according to claim 1,
wherein the housing comprises an operating which exposes a portion of the camera unit, and
an indicator member is provided on an outer surface of the camera unit exposed in the opening, when the camera unit is in the storage position.

7. A portable device according to claim 6,
wherein there are at least two photographing positions, a position at which the camera unit is rotated from the storage position in one direction, and a position at which the camera unit is rotated in another direction, and
the opening is provided at each of the photographing positions.

8. A portable device according to claim 6,
wherein the camera unit comprises two casings which are separable in a shaft direction, and
the indicator member is affixed so as to stride a seam between the two casings.

9. A portable device according to claim 8,
wherein a flat surface is provided which strides the seam between the two casings, and
the indicator member is a label which is adhered upon the flat surface.

10. A portable device according to claim 8,
wherein the indicator member is made from a transparent material, and
printing is performed upon the surface of the indicator member which comes to be on the inside when the indicator member is fitted to the camera unit, or upon the surface which comes to be on the outside, in a position which overlaps the seam.

11. A portable device comprising:
a camera unit having an imaging device;
a housing which supports the camera unit so as to be rotatable, and so that it can be stopped at a photographing position and at a storage position;
an opening which is provided to the housing, and which exposes the image device when the camera unit is stopped in the photographing position;
a detection device which detects that the camera unit is in the photographing position; and
an indicator member which is exposed in the opening at an outer surface of the camera unit, when the detection device does not detect that the camera unit is in the photographing position.

12. A method of controlling a portable device, the portable device comprising:
a camera unit having an imaging device; and
a housing which supports the camera unit so as to be rotatable, and so that it can be stopped at a photographing position and at a storage position, and
the method comprising:
a detection step of detecting, at least, that the camera unit is in the photographing position; and
a starting step of starting the imaging device, when it is detected in the detection step that the camera unit is in the photographing position.

13. A method of controlling a portable device according to claim 12,
wherein the photographing position is at least two locations;
a position in which the camera wait is rotated from the storage position in one direction, and
a position in which it is rotated in another direction.

14. A method of controlling a portable device according to claim 13, wherein the starting step detects which among the plurality of photographing positions the camera unit is in, based upon the result of the detection device, and controls so as in change the orientation in which the image is outputted from the imaging device corresponding to the photographing position which is detected.

15. A method of controlling a portable device according to claim 12, further comprising a camera operation step which can command the starting step to put the imaging device into its starting state, and
wherein the starting step, when the camera operation step is operated, controls the imaging device so as not to start the imaging device, if it is not detected that the camera unit is in the photographing position.
